(19) United States
(12) Patent Application Publication
(10) Pub. No.: US 2008/0233027 A1
(43) Pub. Date: Sep. 25, 2008

(54) Processes for Separating Chlorine from Chlorine-Containing Gas Streams

(75) Inventors: Ole Brettschneider, Berlin (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer MaterialScience AG, Leverkusen (DE)

(21) Appl. No.: 12/051,276

(22) Filed: Mar. 19, 2008

(30) Foreign Application Priority Data
Mar. 23, 2007 (DE) 102007013964.2

(51) Int. Cl. B01D 53/68

(52) U.S. Cl. 423/240 R

(57) ABSTRACT

Processes comprising: providing a gas stream comprising chlorine and at least one secondary component selected from the group consisting of carbon dioxide, nitrogen and oxygen; pressurizing the gas stream in a first stage to an elevated or enhanced pressure, preferably at least about 10 bar; cooling the pressurized gas stream in a second stage comprising a condensation zone and a gas/liquid contact zone disposed below the condensation zone, such that at least a portion of the chlorine is condensed and contacted countercurrently in the gas/liquid contact zone with the pressurized gas stream entering the second stage to form a condensate; and separating the condensate in a third stage comprising a rectifying column to provide a chlorine-rich sump stream and a low-chlorine head stream.

### BACKGROUND OF THE INVENTION

In a large majority of industrial chemical processes, waste gas streams containing multi-component mixtures are formed. The components of various waste gas streams can be super- or sub-critical. Furthermore, depending upon the particular jurisdiction and the scope of legislation, such waste gas components can be regarded as inert or as harmful substances.

In any case, in many processes, efforts are generally made to treat waste gas streams to separate out as completely as possible the harmful substances contained in the waste gas, and to feed such harmful substances in question back into the production process in an economically advantageous manner, so that they are at the same time valuable substances.

In particular, for example, in chlor-alkali electrolysis, HCl electrolysis, the Deacon process and in further chlorochemical processes, waste gas streams consisting of chlorine, carbon dioxide, nitrogen and/or oxygen, as well as farther secondary components, are formed.

Based on the high proportion of components that are not condensable under atmospheric conditions, such as oxygen, nitrogen and CO₂, the chlorine contained in such waste gas streams is generally not recovered but is removed from the waste gas by means of chemical absorption processes and decomposed (see, e.g., European Patent No. EP 0406675 B1, U.S. Pat. No. 3,984,523, and German Patent Publication No. DE 2413358).

### BRIEF SUMMARY OF THE INVENTION

The present invention is directed, in general, to processes for obtaining chlorine from a chlorine-containing waste gas stream, in particular from the chlorine-containing waste gas stream of a chemical production process, and such that the obtained chlorine can be re-used in further chemical production.

One object of the present invention concerns the provision of processes which can simplify the work-up of chlorine-containing waste gas streams and which can avoid the need for absorption processes as described above.

Various embodiments of processes according to the present invention, by contrast, allow chlorine contained in a waste gas to be obtained in a more economical manner, as a result of which it is possible to dispense with downstream chemical absorption of the chlorine, and/or the operating costs of such absorption are reduced significantly.

One embodiment of the present invention includes processes which comprise: providing a gas stream (also referred to herein as “a waste gas stream”) comprising chlorine and at least one secondary component selected from the group consisting of carbon dioxide, nitrogen and oxygen; pressurizing the gas stream in a first stage to an elevated or enhanced pressure, preferably at least about 10 bar; cooling the pressurized gas stream in a second stage comprising a condensation zone and a gas/liquid contact zone disposed below the condensation zone, such that at least a portion of the chlorine is condensed and contacted countercurrently in the gas/liquid contact zone with the pressurized gas stream entering the second stage to form a condensate; and separating the condensate in a third stage comprising a rectifying column to provide a chlorine-rich sump stream and a low-chlorine head stream. As used herein, “an elevated or enhanced pressure” refers to an increased pressure level, i.e., any pressure greater than the pressure of the waste gas stream prior to pressurizing, and is preferably at least about 10 bar.

The present invention includes processes for obtaining chlorine from a waste gas stream, in particular from the waste gas stream of a chemical production process, characterized in that in a first stage, the waste gas stream is brought to an elevated or enhanced pressure, preferably at least about 10 bar (10,000 hPa); in a second stage, the waste gas stream coming from the first stage is cooled and some or all of the chlorine contained therein is separated off by condensation together with a portion of the other condensable or soluble components contained in the waste gas, and the condensate formed thereby is brought into contact countercurrently, in a gas-liquid contact zone provided beneath the condensation zone, with the waste gas stream entering the second stage; in a third stage, the condensate coming from the second stage is divided in a rectifying column into a chlorine-rich sump stream and a gaseous and a liquid, low-chlorine head stream, and the chlorine-rich sump stream can then be worked up in order to obtain chlorine, optionally for further use in subsequent processing.

Another embodiment of the present invention includes processes which comprise: providing a gas stream comprising chlorine, carbon dioxide, nitrogen and oxygen; pressurizing the gas stream in a first stage to a pressure of about 10 bar to 60 bar; cooling the pressurized gas stream in a second stage comprising a condensation zone and a gas/liquid contact zone disposed below the condensation zone, such that at least a portion of the chlorine is condensed and contacted countercurrently in the gas/liquid contact zone with the pressurized gas stream entering the second stage to form a condensate, wherein the pressurized gas stream is cooled in the second stage to a condensation temperature of −20° C. to −80° C.; and separating the condensate in a third stage comprising a rectifying column to provide a chlorine-rich sump stream and a low-chlorine head stream; wherein heat is exchanged during the process between one or both of: (i) the pressurized gas stream from the first stage and a head condensate from the rectifying column; and (ii) the pressurized gas stream from the first stage and a waste gas stream from the second stage.

### BRIEF DESCRIPTION OF THE SEVERAL VIEWS OF THE DRAWING

The foregoing summary, as well as the following detailed description of the invention, may be better understood when read in conjunction with the appended drawings. For the purpose of assisting in the explanation of the invention, there are shown in the drawings representative embodiments which are considered illustrative. It should be understood, however, that the invention is not limited in any manner to the precise arrangements and instrumentalities shown.

In the drawings:

FIG. 1 is a process flow diagram of one embodiment of a process according to the invention;

FIG. 2 is a process flow diagram of another embodiment of a process according to the invention; and

FIG. 3 is a process flow diagram of another embodiment of a process according to the invention.

### DETAILED DESCRIPTION OF THE INVENTION

As used herein, the singular terms “a” and “the” are synonymous and used interchangeably with “one or more” and “at least one,” unless the language and/or context clearly indicate otherwise. Accordingly, for example, reference to “a gas stream” herein or in the appended claims can refer to a single stream or more than one stream. Additionally, all numerical values, unless otherwise specifically noted, are understood to be modified by the word “about.”

In various preferred process embodiments according to the present invention, the waste gas stream to be pressurized can comprise at least nitrogen, oxygen, carbon dioxide and chlorine.

In various preferred process embodiments according to the present invention, in the first stage, the waste gas stream can be adjusted to a pressure of 10 to 60 bar, preferably 20 to 50 bar, and more preferably 30 to 40 bar.

In various preferred process embodiments according to the present invention, the condensation temperature in the second and/or third stages, preferably both, can be −20° C. to −80° C.

In various preferred process embodiments according to the present invention, heat can be exchanged between the pressurized gas stream coming from the first stage and the head condensate from the third stage, and the condensate from the third stage can be vaporized. Such heat exchange can allow processes according to various preferred embodiments to be carried out in manner that is advantageous in terms of energy.

In various preferred process embodiments according to the present invention, heat can also, or alternatively, be exchanged between a gas stream leaving the second stage and the pressurized gas stream entering the second stage.

In various preferred process embodiments according to the present invention, gas streams leaving the second and third stages can first be mixed, and heat can then be exchanged between the mixture of gases and the pressurized gas stream entering the second stage.

Process according to the various embodiments of the present invention can preferably use a chlorine-containing waste gas stream originating from a production process for the preparation of chlorine from hydrogen chloride and oxygen, in particular from a catalyzed gas-phase oxidation of hydrogen chloride and/or from a non-thermal reaction of hydrogen chloride and oxygen.

A chlorine-containing waste gas stream from a catalytic process known as the Deacon process can preferably be used. In a Deacon process, hydrogen chloride is oxidized to chlorine with oxygen in an exothermic equilibrium reaction, with the formation of water vapor. The reaction temperature is conventionally from 150 to 500° C. and the conventional reaction pressure is from 1 to 25 bar. Because the reaction is an equilibrium reaction, it is advantageous to work at the lowest possible temperatures at which the catalyst still has sufficient activity. It is also advantageous to use oxygen in over-stoichiometric amounts relative to the hydrogen chloride. A two- to four-fold oxygen excess, for example, is conventional. Because there is no risk of losses of selectivity, it can be economically advantageous to work at a relatively high pressure and accordingly with a longer residence time as compared with normal pressure.

Suitable preferred catalysts for a Deacon process comprise ruthenium oxide, ruthenium chloride or other ruthenium compounds on silicon dioxide, aluminum oxide, titanium dioxide or zirconium dioxide as a support. Suitable catalysts can be obtained, for example, by applying ruthenium chloride to the support and then drying or drying and calcining. In addition to, or instead of, a ruthenium compound, suitable catalysts can also comprise compounds of other noble metals, for example gold, palladium, platinum, osmium, iridium, silver, copper or rhenium. Suitable catalysts can also contain chromium(III) oxide.

The catalytic hydrogen chloride oxidation can be carried out adiabatically or isothermally or approximately isothermally, discontinuously, but preferably continuously as a fluid or fixed bed process, preferably as a fixed bed process, particularly preferably in tubular reactors on heterogeneous catalysts at a reactor temperature of from 180 to 500° C., preferably from 200 to 400° C., particularly preferably from 220 to 350° C., and a pressure of from 1 to 25 bar (from 1000 to 25,000 hPa), preferably from 1.2 to 20 bar, particularly preferably from 1.5 to 17 bar and especially from 2.0 to 15 bar.

Conventional reaction apparatuses in which the catalytic hydrogen chloride oxidation is carried out are fixed bed or fluidized bed reactors. The catalytic hydrogen chloride oxidation can preferably also be carried out in a plurality of stages.

In the case of an isothermal or approximately isothermal procedure and also in the case of an adiabatic procedure, it is also possible to use a plurality of reactors, that is to say from 2 to 10, preferably from 2 to 6, particularly preferably from 2 to 5, especially 2 or 3 reactors, connected in series with intermediate cooling. The oxygen can either be added in its entirety, together with the hydrogen chloride, upstream of the first reactor, or distributed over the various reactors. This series connection of individual reactors can also be combined in one apparatus.

A further preferred form of a device suitable for such processes includes using a structured bulk catalyst in which the catalytic activity increases in the direction of flow. Such structuring of the bulk catalyst can be effected by variable impregnation of the catalyst support with active substance or by variable dilution of the catalyst with an inert material. As the inert material there can be used, for example, rings, cylinders or spheres of titanium dioxide, zirconium dioxide or mixtures thereof, aluminum oxide, steatite, ceramics, glass, graphite or stainless steel. When catalyst shaped bodies are used, as is preferred, the inert material should preferably have similar outside dimensions.

Suitable catalyst shaped bodies are shaped bodies of any shape, preferred shapes being lozenges, rings, cylinders, stars, cart wheels or spheres and particularly preferred shapes being rings, cylinders or star-shaped extrudates.

Suitable heterogeneous catalysts include, in particular, ruthenium compounds or copper compounds on support materials, which can also be doped, with preference being given to optionally doped ruthenium catalysts. Examples of suitable support materials include silicon dioxide, graphite, titanium dioxide of rutile or anatase structure, zirconium dioxide, aluminum oxide or mixtures thereof, preferably titanium dioxide, zirconium dioxide, aluminum oxide or mixtures thereof, particularly preferably γ- or δ-aluminum oxide or mixtures thereof.

The copper or ruthenium supported catalysts can be obtained, for example, by impregnating the support material with aqueous solutions of CuCl₂ or RuCl₃ and optionally of a promoter for doping, preferably in the form of their chlorides. Shaping of the catalyst can take place after or, preferably, before the impregnation of the support material.

Suitable promoters for the doping of the catalysts include alkali metals such as lithium, sodium, potassium, rubidium and cesium, preferably lithium, sodium and potassium, particularly preferably potassium, alkaline earth metals such as magnesium, calcium, strontium and barium, preferably magnesium and calcium, particularly preferably magnesium, rare earth metals such as scandium, yttrium, lanthanum, cerium, praseodymium and neodymium, preferably scandium, yttrium, lanthanum and cerium, particularly preferably lanthanum and cerium, or mixtures thereof.

The shaped bodies can then be dried and optionally calcined at a temperature of 100 to 400° C., preferably 100 to 300° C., for example, under a nitrogen, argon or air atmosphere. The shaped bodies are preferably first dried at 100 to 150° C. and then calcined at 200 to 400° C.

The hydrogen chloride conversion in a single pass can preferably be limited to 15 to 90%, preferably 40 to 85%, particularly preferably 50 to 70%. After separation, some or all of the unreacted hydrogen chloride can be fed back into the catalytic hydrogen chloride oxidation. The volume ratio of hydrogen chloride to oxygen at the entrance to the reactor is preferably from 1:1 to 20:1, preferably from 2:1 to 8:1, particularly preferably from 2:1 to 5:1.

The heat of reaction of the catalytic hydrogen chloride oxidation can advantageously be used to produce high-pressure steam. This can be used to operate a phosgenation reactor and/or distillation columns, in particular isocyanate distillation columns.

In a final step of the Deacon process, the chlorine formed in the Deacon reaction is separated off. The separation step conventionally comprises a plurality of stages, namely the separation and optional recycling of reacted hydrogen chloride from the product gas stream of the hydrogen chloride oxidation, drying of the resulting stream containing substantially chlorine and oxygen, and the separation of chlorine from the dried stream.

The separation of unreacted hydrogen chloride and of water vapor that has formed can be carried out by removing aqueous hydrochloric acid from the product gas stream of the hydrogen chloride oxidation by cooling. Hydrogen chloride can also be absorbed in dilute hydrochloric acid or water.

The chlorine-containing waste gas stream underlying the novel process can be, for example, the residual gas stream remaining after separation of the chlorine, or a portion thereof.

In a first stage of various embodiments of the processes according to the present invention, the chlorine-containing waste gas stream is compressed to a required process pressure. The level of pressure to be chosen depends substantially on the required residual chlorine content of the waste gas at the outlet from the novel process and also on the level of cold available for the subsequent condensation/rectification steps. The pressure level of at least about 10 bar, is preferably 10 to 60 bar, more preferably 20 to 50 bar, and most preferably 30 to 40 bar.

The pressure level can be adjusted in particular with the aid of conventional pressure-increasing machines for gas streams, for example piston compressors, turbo compressors or liquid ring pumps. Furthermore, the compression can preferably be carried out in one or more stages, with or without intermediate cooling.

In a second stage of various embodiments of the processes according to the present invention, at least a portion of the chlorine contained in the pressurized waste gas is separated off by condensation. The temperature used therefor is determined especially by the chosen pressure level or by the chlorine concentration that is to be achieved in the gas mixture leaving the second stage. Advantageously, the heat-exchange apparatus used for the condensation is equipped with an upstream gas-liquid contact zone, which is arranged in particular beneath the heat exchanger and in which the condensate that forms is brought into contact with the gas stream entering the second stage. Contact between the incoming gas stream and the condensate is effected countercurrently. Gas-liquid contact can optionally be carried out in the presence of built-in elements such as material-exchange plates through structured or random packings. Suitable possible types of apparatus for the condensation are tubular heat exchangers, plate heat exchangers, spiral heat exchangers or block heat exchangers arranged horizontally or vertically.

At a bottom end of the contact zone, the condensate is collected in an apparatus sump. The composition of the condensate depends substantially on the composition of the incoming gas stream, on the chosen pressure and temperature level and on the number of equilibrium stages passed through countercurrently in the described gas-liquid contact zone.

The condensation temperature, which can depend on the chosen pressure level, is preferably −20° C. to 60° C.

The chlorine concentration of the gas stream emerging at the head condenser is preferably 0 to 40 wt. %, more preferably 0 to 5 wt. %.

The chlorine concentration of the condensate emerging at the head condenser is preferably from 0 to 99 wt. %, more preferably from 0 to 90 wt. %, and the chlorine concentration of the condensate is generally higher than that of the emerging gas stream at the head condenser.

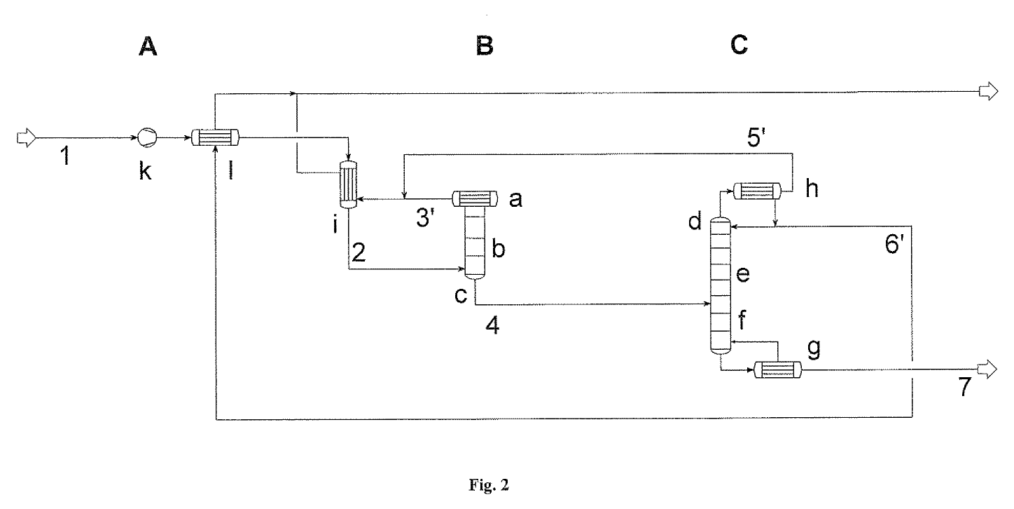

The novel processes according to the present invention can further include optional preferred measures for heat exchange, as shown, for example, in FIG. 2.

In this regard, in various preferred embodiment of processes according to the present invention, a condensate stream from the rectifying column of the third stage can be vaporized in a first heat exchanger downstream of the first stage, and the waste gas stream coming from the first stage is thereby cooled (e.g., “pre-cooled” prior to entering the second stage). Possible types of apparatus for this purpose are tubular heat exchangers, plate heat exchangers, spiral heat exchangers or block heat exchangers arranged horizontally or vertically.

Further in this regard, in various preferred embodiment of processes according to the present invention, heat exchange can further include the use of a recuperator, in which heat is exchanged between the waste gas stream coming from the first stage, which has optionally already been cooled in the first above-mentioned heat exchanger, and the waste gas stream coming from the second stage. Suitable possible types of apparatus for a recuperator are tubular heat exchangers, plate heat exchangers, spiral heat exchangers or block heat exchangers arranged horizontally or vertically.

It is likewise possible to mix the gas stream leaving the second stage with the waste gas stream leaving the third stage and to use the mixture in the recuperator.

In the third stage, the condensate leaving the apparatus sump of the second stage is rectified. To this end, the condensate is preferably fed to a rectifying column between the concentrating section and the stripping section. In the column, preferably, the vapor stream produced in the vaporizer is brought into contact, in a plurality of stages and countercurrently, with a portion of the vapor condensed in the head condenser, the head condensate. Gas-liquid contact can optionally be carried out through material-exchange plates or through structured or random packings.

The head condenser can in particular be in the form of a partial condenser in order to allow inert components to be discharged in the gaseous state. Part of the condensate that forms is then fed back to the column. The chlorine concentrations at the column head and at the column sump depend substantially on the energy supplied to the vaporizer and on the amount of condensate fed back to the column. Preferably, the chlorine concentration so adjusted in the stream drawn off at the column sump is from 50 to 100 wt. %, preferably ftom 90 to 100 wt. %.

The invention will now be described in further detail with reference to the following non-limiting examples.

### EXAMPLES

### Example 1

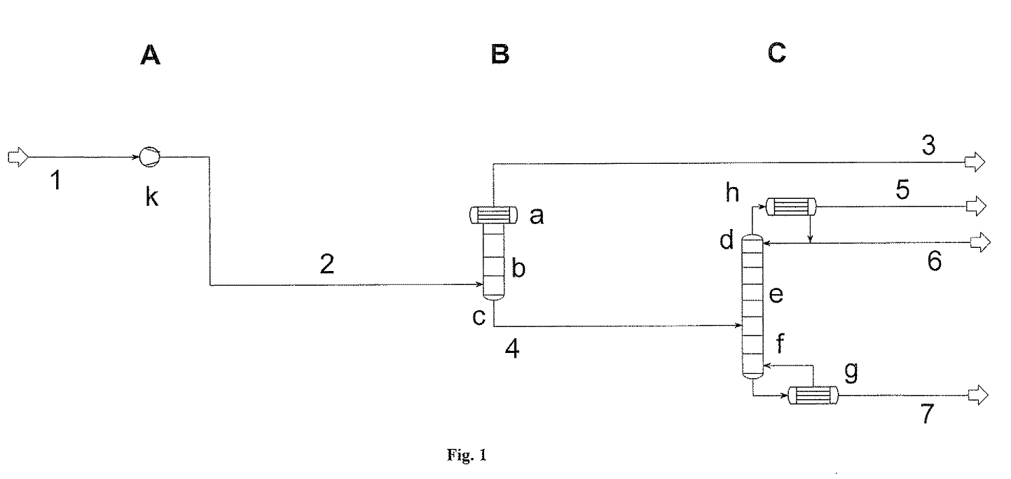

Referring to FIG. 1, the waste gas stream 1 of an upstream Deacon process (not shown), consisting of nitrogen, oxygen and carbon dioxide with a proportion of chlorine in the order of magnitude of 10 wt. %, is brought to a pressure of 35 bar (35,000 hPa) in the first stage A by means of a fan (compressor) k.

The compressed stream 2 is fed in the second stage B to a gas-liquid contact zone b in which the gas stream 2 is brought into contact with condensed chlorine. Above the gas-liquid contact zone b is a condenser a in which chlorine is condensed at a temperature of −42° C. The chlorine condensate is collected in the sump c of the gas-liquid contact zone b and fed as stream 4 to the third stage C. The uncondensed gases are discharged as stream 3 and are re-used or discarded as required, optionally after destruction of very small residual amounts of chlorine.

The condensate 4 is fed to a rectifying column d and applied in the middle region between the concentrating section e and the stripping section f. A vaporizer g is arranged downstream of the sump of the column d, and a condenser h is arranged downstream of the head.

In the column, the vapor stream produced in the vaporizer g is brought into contact, in a plurality of stages and countercurrently, with a portion of the vapor condensed in the head condenser h, the head condensate. Gas-liquid contact is effected by means of material-exchange plates (not shown).

The head condenser h is in the form of a partial condenser in order to allow inert components to be discharged in the gaseous state (stream 5). Part of the condensate that forms is fed back to the column d. The chlorine concentrations at the column head (streams 5 and 6) and at the column sump (stream 7) depend substantially on the energy supplied to the vaporizer and on the amount of condensate fed back to the column. The chlorine concentration in the stream 7 drawn off at the column sump is 90 wt. %.

### Example 2

Referring to FIG. 2, the condensate stream 6′ from the rectifying column of stage C is vaporized in a first tubular heat exchanger 1 downstream of the fan k, and the waste gas stream coming from the first stage A is cooled thereby. The pre-cooled waste gas stream 2′ is passed through a recuperator (tubular heat exchanger i), in which heat is exchanged between the waste gas stream 2′ and the waste gas stream 3′ coming from the second stage B.

In addition, the gas stream 5′ leaving the third stage C is mixed with the gas stream 3′ leaving the head condenser a, and the mixture is passed through the recuperator i and then combined with the stream 6′ leaving the tubular heat exchanger 1 and discharged.

### Example 3

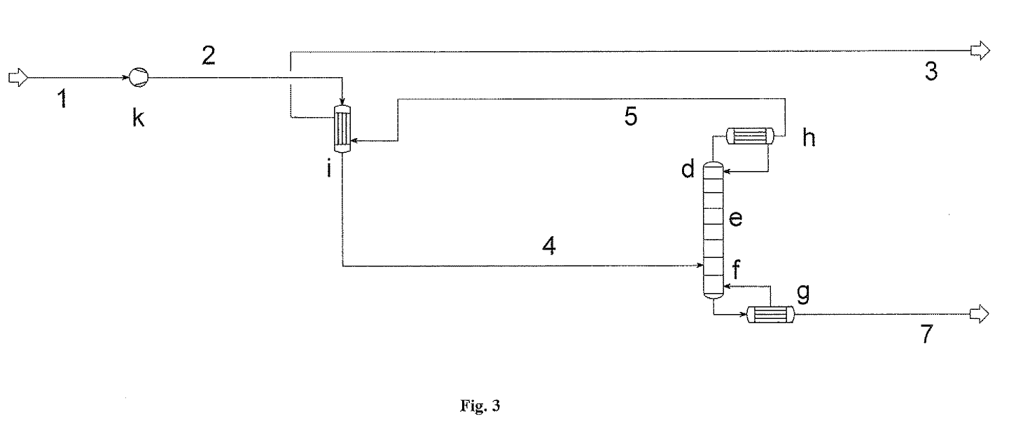

Referring to FIG. 3, heat is exchanged between the stream 2 and the stream 5 in a recuperator i downstream of the fan k. The stream 4 so obtained is fed directly to a rectifying column d. The stream 3 is discharged and re-used or discarded as required, optionally after destruction of very small residual amounts of chlorine that may remain.

In the column, the vapor stream produced in the vaporizer g is brought into contact, in a plurality of stages and countercurrently, with the vapor condensed in the head condenser h. Gas-liquid contact is effected by means of material-exchange plates (not shown).

The head condenser h is in the form of a partial condenser in order to allow inert components to be discharged in the gaseous state (stream 5). The condensate that forms is fed back to the column d. The chlorine concentrations at the column head (stream 5, FIG. 3) and at the column sump (stream 7) depend substantially on the energy supplied to the vaporizer and on the amount of condensate fed back to the column. The chlorine concentration in the stream 7 drawn off at the column sump is 90 wt. %.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
providing a gas stream comprising chlorine and at least one secondary component selected from the group consisting of carbon dioxide, nitrogen and oxygen;
pressurizing the gas stream in a first stage to a pressure of at least about 10 bar;
cooling the pressurized gas stream in a second stage comprising a condensation zone and a gas/liquid contact zone disposed below the condensation zone, such that at least a portion of the chlorine is condensed and contacted countercurrently in the gas/liquid contact zone with the pressurized gas stream entering the second stage to form a condensate; and
separating the condensate in a third stage comprising a rectifying column to provide a chlorine-rich sump stream and a low-chlorine head stream.

2. The process according to claim 1, further comprising working up the chlorine-rich sump stream to provide chlorine.

3. The process according to claim 1, wherein the gas stream comprises carbon dioxide, nitrogen and oxygen.

4. The process according to claim 1, wherein the gas stream is pressurized to a pressure of 10 to 60 bar.

5. The process according to claim 3, wherein the gas stream is pressurized to a pressure of 10 to 60 bar.

6. The process according to claim 1, wherein the gas stream is pressurized to a pressure of 30 to 40 bar.

7. The process according to claim 3, wherein the gas stream is pressurized to a pressure of 30 to 40 bar.

8. The process according to claim 1, wherein the pressurized gas stream is cooled in the second stage to a condensation temperature of −20° C. to −80° C.

9. The process according to claim 3, wherein the pressurized gas stream is cooled in the second stage to a condensation temperature of −20° C. to −80° C.

10. The process according to claim 5, wherein the pressurized gas stream is cooled in the second stage to a condensation temperature of −20° C. to −80° C.

11. The process according to claim 1, wherein the chlorine-rich sump stream in the third stage has a condensation temperature of −20° C. to −80° C.

12. The process according to claim 8, wherein the chlorine-rich sump stream in the third stage has a condensation temperature of −20° C. to −80° C.

13. The process according to claim 1, wherein heat is exchanged between the pressurized gas stream from the first stage and a head condensate from the rectifying column.

14. The process according to claim 13, wherein at least a portion of the head condensate is vaporized.

15. The process according to claim 3, wherein heat is exchanged between the pressurized gas stream from the first stage and a head condensate from the rectifying column.

16. The process according to claim 5, wherein heat is exchanged between the pressurized gas stream from the first stage and a head condensate from the rectifying column.

17. The process according to claim 1, wherein heat is exchanged between the pressurized gas stream from the first stage and a waste gas stream from the second stage.

18. The process according to claim 11, wherein the waste gas stream from the second stage and a waste gas stream from the third stage are mixed prior to heat exchange with the pressurized gas stream from the first stage.

19. The process according to claim 1, wherein the gas stream comprising chlorine and at least one secondary component is obtained from a production process for the preparation of chlorine from hydrogen chloride and oxygen.

20. A process comprising:
providing a gas stream comprising chlorine, carbon dioxide, nitrogen and oxygen;
pressurizing the gas stream in a first stage to a pressure of about 10 bar to 60 bar;
cooling the pressurized gas stream in a second stage comprising a condensation zone and a gas/liquid contact zone disposed below the condensation zone, such that at least a portion of the chlorine is condensed and contacted countercurrently in the gas/liquid contact zone with the pressurized gas stream entering the second stage to form a condensate, wherein the pressurized gas stream is cooled in the second stage to a condensation temperature of −20° C. to −80° C.; and
separating the condensate in a third stage comprising a rectifying column to provide a chlorine-rich sump stream and a low-chlorine head stream;
wherein heat is exchanged during the process between one or both of: (i) the pressurized gas stream from the first stage and a head condensate from the rectifying column; and (ii) the pressurized gas stream from the first stage and a waste gas stream from the second stage.
